(19) United States
(12) Patent Application Publication
(10) Pub. No.: US 2003/0161142 A1
(43) Pub. Date: Aug. 28, 2003

(54) Method and apparatus for lighting made from different materials

(76) Inventor: Irwin Kotovsky, Pittsburgh, PA (US)

Correspondence Address: Ansel M. Schwartz, Suite 304, 201 N. Craig Street, Pittsburgh, PA, 15213, US

(21) Appl. No.: 10/163,014

(22) Filed: May 31, 2002

Related U.S. Application Data
(63) Continuation-in-part of application No. 10/084,740, filed on Feb. 22, 2002.

(51) Int. Cl. F21S 8/00; F21S 8/04

(52) U.S. Cl. 362/147; 362/148; 362/146; 362/219; 362/221; 362/223; 362/225

(57) ABSTRACT

An apparatus for lighting a room from the room's ceiling or wall. The apparatus includes means for lighting including at least one lamp and one transformer electrically connected to the lamp, the lamp being either a low voltage or line voltage lamp. The apparatus includes means for holding the lamp connected to the lighting means. The apparatus includes a panel having at least one hole in which the holding means is disposed. The panel is made of wood, glass, plastic, marble or synthetic. A method for lighting a room from its ceiling or wall.

### FIELD OF THE INVENTION

The present invention is related to a lighting apparatus having an exterior surface that can be made from a multitude of different materials. More specifically, the present invention is related to a lighting apparatus for low voltage or line voltage lamps that can be made out of or having an exterior surface made out of a multitude of different materials.

### BACKGROUND OF THE INVENTION

Lights have always been a functional necessity in any enclosure from the time they were first available. Besides the light providing a necessary function to allow people to see inside an enclosure, the lights themselves have at times taken on an esthetic or artistic quality to better enhance the environment in which they are placed. The present invention furthers this ascetic or artistic quality by allowing the apparatus for lighting to be able to be of a multitude of different materials depending on the aesthetic environment in which they are found and which the architect or designer wishes to enhance or create.

### SUMMARY OF THE INVENTION

The present invention pertains to an apparatus for lighting a room from the room's ceiling or wall. The apparatus comprises means for lighting including at least one lamp and one transformer electrically connected to the lamp. The lamp is either a low voltage or a line voltage lamp. The apparatus comprises a housing for holding the lamp, the housing having an outer surface made of wood, plastic, glass, marble or synthetic. The apparatus comprises means for attaching the housing to the ceiling or wall.

The present invention pertains to a method for forming a lighting apparatus. The method comprises the steps of placing an outer layer about an interior of a housing. There is the step of introducing a lamp socket connected to a transformer adjacent the housing for either a low voltage or a line voltage lamp.

The present invention pertains to a method for lighting a room. The method comprises the steps of attaching a housing having an interior made of metal and an outer layer made of wood to a ceiling or wall. There is the step of introducing a low voltage or a line voltage lamp into a lamp socket connected to a transformer adjacent the housing.

The present invention pertains to an apparatus for lighting a room from the room's ceiling or wall. The apparatus comprises means for lighting including at least one lamp and one transformer or ballast or gear electrically connected to the lamp, the lamp being either a low voltage or line voltage lamp. The apparatus comprises means for holding the lamp connected to the lighting means. The apparatus comprises a panel having at least one hole in which the holding means is disposed. The panel is made of wood, glass, plastic, marble or synthetic.

The present invention pertains to a method for lighting a room from its ceiling or wall. The method comprises the steps of mounting a gimbal ring assembly for holding a lamp in an opening of a one-piece panel made of wood, glass, plastic, marble or synthetic. There is the step of fixing the panel with the gimbal ring assembly mounted to the panel to the ceiling or wall.

### BRIEF DESCRIPTION OF THE DRAWINGS

In the accompanying drawings, the preferred embodiment of the invention and preferred methods of practicing the invention are illustrated in which:

FIG. 1 is a schematic representation of an apparatus of the present invention.

FIGS. 2-4 are schematic representations of bottom, side and end views, respectively, of an apparatus whose corners are mitered.

FIGS. 5-7 are schematic representations of bottom, side and end views, respectively, of an apparatus whose corners are butted.

FIGS. 8-10 are schematic representations of an apparatus bottom, side and end views, respectively, whose corners overlap.

FIGS. 11 and 12 are schematic representations of an apparatus perspective view suspended from the ceiling, with a closer view of the lamp, respectively.

FIG. 13 is a schematic representation of a panel with gimbal ring assemblies attached to the panel in its holes.

### DETAILED DESCRIPTION

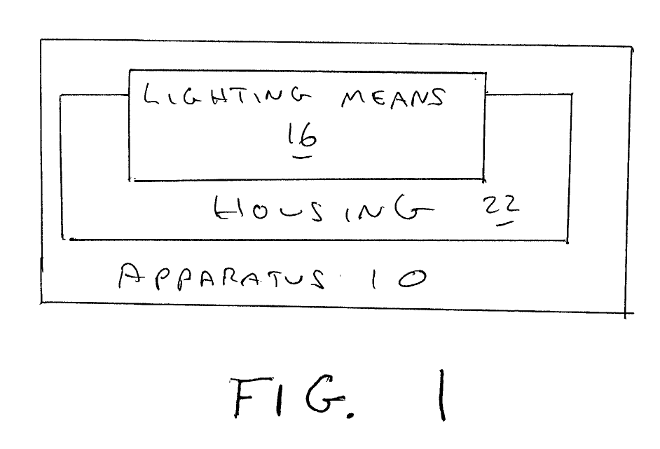

Referring now to the drawings wherein like reference numerals refer to similar or identical parts throughout the several views, and more specifically to FIG. 1 thereof, there is shown an apparatus 10 for lighting a room 12 from the room's 12 ceiling 14 or wall. The apparatus 10 comprises means 16 for lighting including at least one lamp 18 and one transformer 20 electrically connected to the lamp 18. The lamp 18 is either a low voltage or a line voltage lamp 18. The apparatus 10 comprises a housing 22 for holding the lamp 18, the housing 22 having an outer surface 24 made of wood, plastic, glass, marble or synthetic. The apparatus 10 can include means for attaching the housing 22 to the ceiling 14 or wall.

Preferably, the housing 22 includes an interior 26, and an outer layer 28 positioned about the interior 26, the outer layer 28 having the outer surface 24, the outer layer 28 made of wood, metal, plastic, glass, marble or synthetic. The housing 22 preferably has a rectangular shape. Preferably, the lighting means 16 includes at least a second lamp 18. The lighting means 16 preferably includes a yoke 30 which holds the lamp 18. Preferably, the lighting means 16 includes a gimbal ring 32 assembly having the yoke 30 for holding the lamp 18.

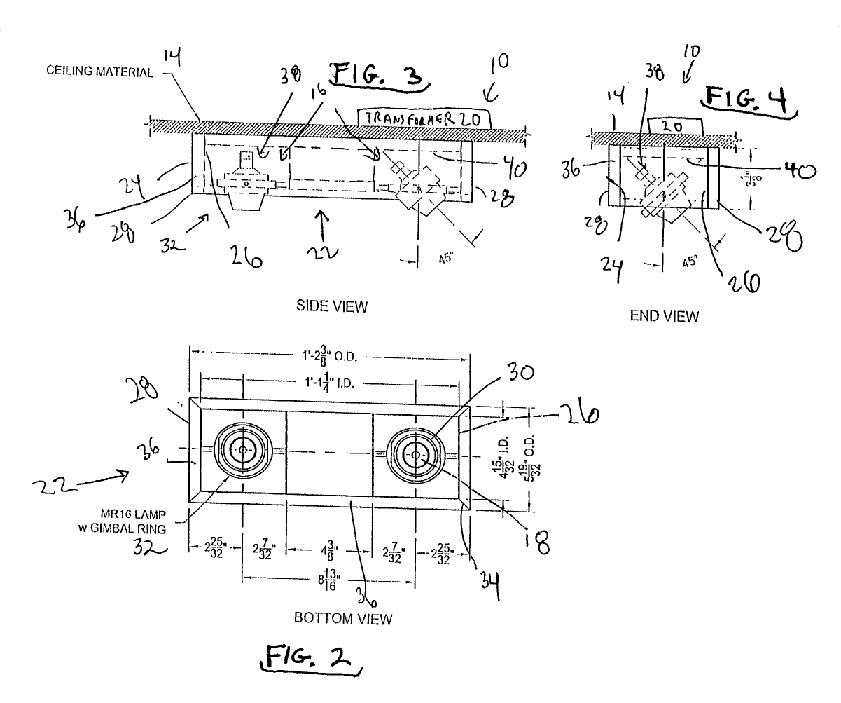

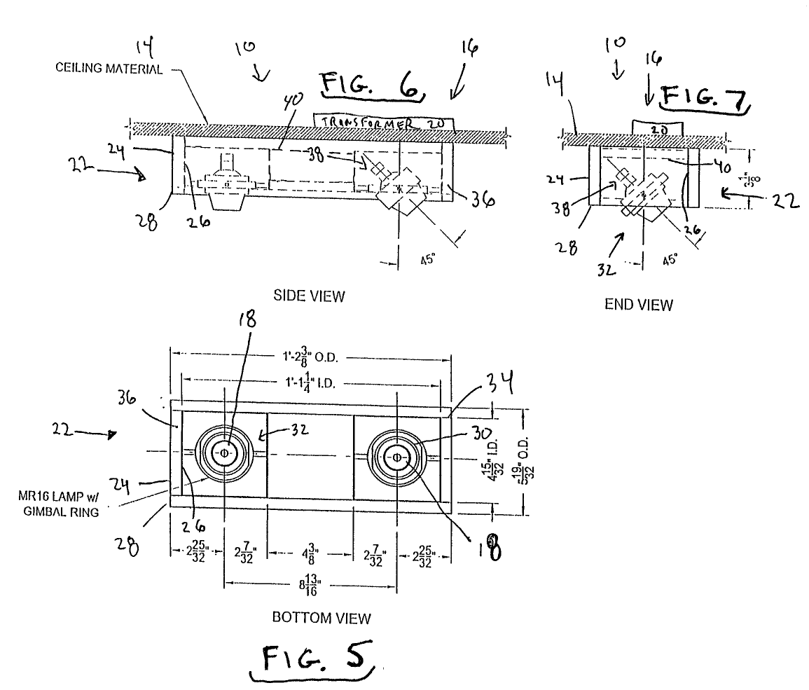

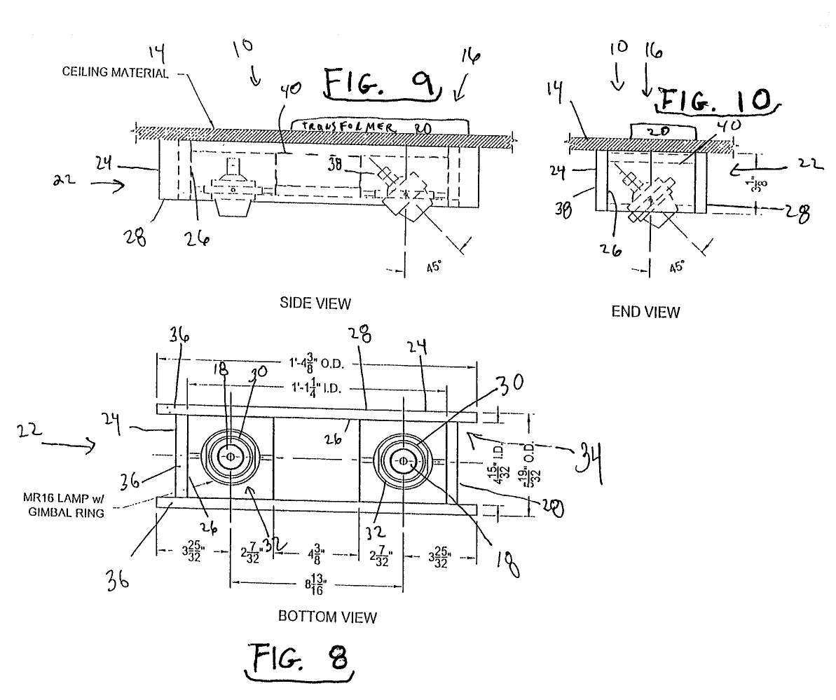

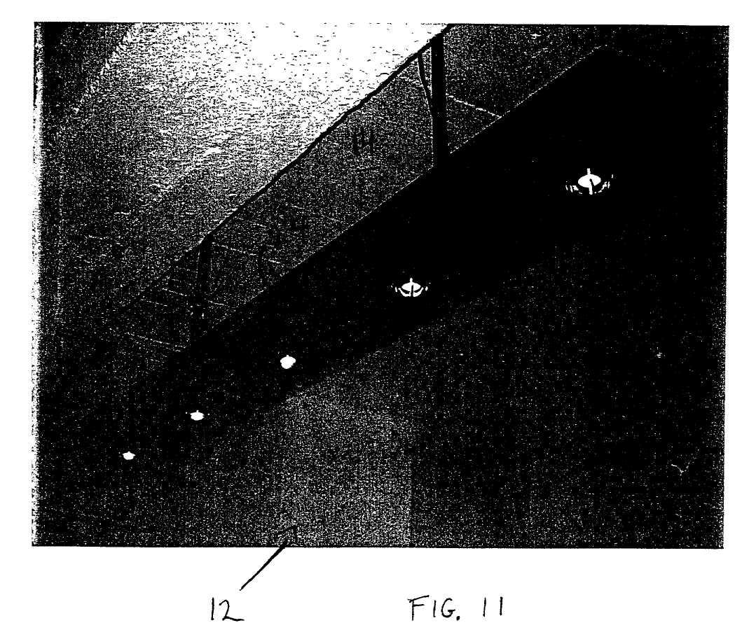

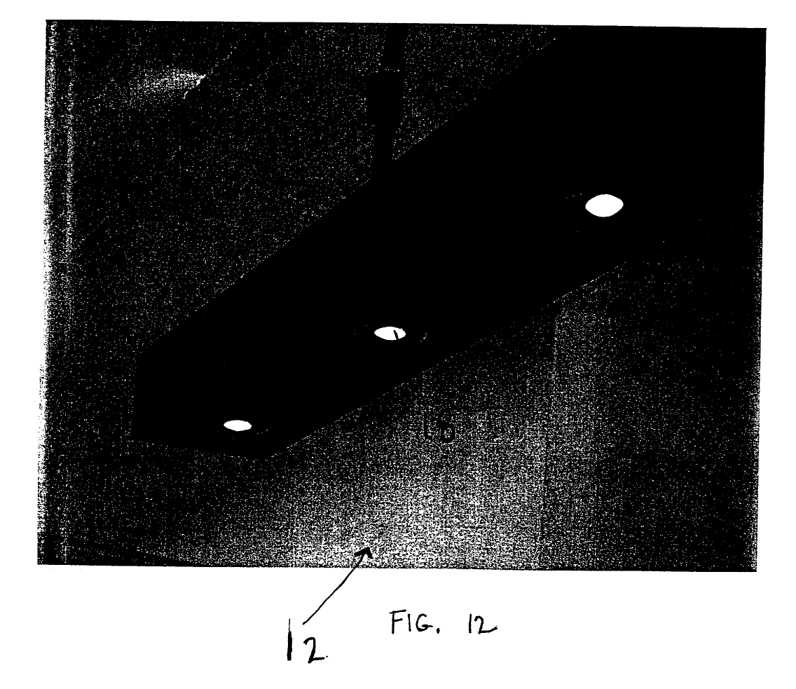

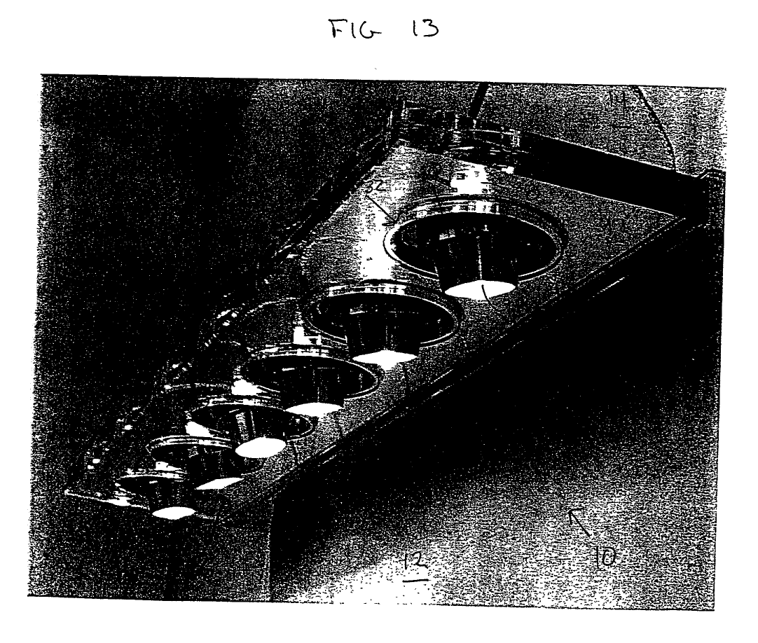

The housing 22 preferably has corners 34 which are mitered, butted, or overlapped, as shown in FIGS. 2-4, 5-7, and 8-10, respectively. Preferably, the outer layer 28 is formed of plates 36. The plates 36 are preferably regressed, flush or protruding with respect to the housing 22 circumference. Preferably, the plates 36 are fixed, interchangeable or removable. The housing 22 is preferably surface mounted, suspended, as shown in FIGS. 11 and 12, semi-recessed, or recessed from the ceiling 14 or wall mounted. The length or long dimension of the housing can be parallel or perpendicular to the wall. Preferably, the lighting means 16 includes a lamp 18 socket 38 for holding the lamp 18, and the housing 22 includes a metal heat plate 40 disposed adjacent the housing 22 top having an opening through which the socket 38 extends. The metal heat plate 40 transmits heat away from the lamp 18 socket 38. The transformer 20 is preferably integral or remote from the housing 22. Preferably, the transformer 20 is attached or detached adjacent the housing 22.

The present invention pertains to a method for forming a lighting apparatus 10. The method comprises the steps of placing an outer layer 28 about an interior 26 of a housing 22. There is the step of introducing a lamp 18 socket 38 connected to a transformer 20 adjacent the housing 22 for either a low voltage or a line voltage lamp 18.

The present invention pertains to a method for lighting a room 12. The method comprises the steps of attaching a housing 22 having an interior 26 made of metal or plastic and an outer layer 28 made of wood to a ceiling 14 or wall. There is the step of introducing a low voltage or a line voltage lamp 18 into a lamp 18 socket 38 connected to a transformer 20 adjacent the housing 22.

In the operation of the invention, a lighting apparatus 10, such as that provided by Modular International, Inc. called LINEARS, or found in U.S. Pat. No. 6,234,644, incorporated by reference herein, or essentially any lighting apparatus 10 that has a housing 22 which supports low voltage or line voltage lamps 18 can be the basis for the present invention. The housing 22 for the lamps 18 can be made of entirely, or partially, of wood (solid, laminated, veneered), metal (steel, stainless steel, aluminum), plastics (acrylic, polycarbonate), glass (laminated, tempered, water white), marble (onyx, travertine, stone, ceramic), or synthetic. Alternatively, the housing 22 itself can be of standard metal formation with an outer layer 28 formed of plates 36 made of wood (solid, laminated, veneered), metal (steel, stainless steel, aluminum), plastics (acrylic, polycarbonate), glass (laminated, tempered, water white), marble (onyx, travertine, stone, ceramic), or synthetic. The corner 34 construction of the housing 22 if it is made entirely of a desired material and other than standard metal, or plates 36 are used on a standard metal housing 22, the corner 34 construction can be mitered, butted, or overlapped. The shape of the housing 22 can be round, straight (90 degrees), or angled. The corners 34 themselves can the glued, stapled, pinned or clipped together.

If plates 36 are used, they can be regressed, flush or protruding (extending below the sides) relative to the housing 22. The plates 36 can be fixed to the housing 22 or interchangeable with the housing 22. The plates 36 can be magnetically held, either with magnetic strips adhered to the plates 36, or with magnets strong enough placed inside the housing 22 which also holds the plates 36 to the housing 22 wall. The plates 36 can be screw held, the screws and penetrating through the respective plate and the housing 22 wall. The plates 36 can be Velcro held, with the pins of the Velcro disposed on either the plate or the housing 22 and the loops of the Velcro disposed and in alignment with the pins on the opposing plate or housing 22 side. The plates 36 can be snap or fastener held or held by lift and shift design. The plates 36 can be laser cut, water cut, stamped, forged, bent, machined, molded, die cast or saw cut.

If plates 36 are used, they can be applied only to the surfaces that are exposed for viewing by people in the enclosure in which the lighting apparatus 10 is located. For instance, if the lighting apparatus 10 is recessed, then the plates 36 need only be applied to the bottom surface of the lighting apparatus 10 which is exposed to viewing by people in the enclosure. The mounting of the lighting apparatus 10 can be surface mounted, suspended, semi-recessed, or recessed. In each of these instances, the standard techniques known to one skilled in the art are used to hold the lighting apparatus 10 in position. The length of the lighting apparatus 10, is essentially unconstrained, being able to extend the length of a room 12, if desired.

The lamps 18 and the lighting apparatus 10 can be held by sockets, rings free-floating, yokes, gimbal rings or plug in systems or other commonly used quick disconnect systems in low voltage or line voltage systems. The lamp 18 sockets 38 can be 120 volt candelabra based, intermediate based, medium based, mogel based or bayonet based; or the sockets can be for low voltage lamps, such as MR11, MR16, AR70 or AR111. The lamps 18 can be flush with the bottom, regressed above the bottom, or protruding below the bottom of the housing 22. Transformers 20 and/or gear for the lamps 18 can be integral, remote or contained in attached or detached adjacent housing 22. Linear fluorescent lamps, such as T2 and T5 and BiAx are available, as well as a variety of PL lamps for either clip in or screw in sockets.

A metal plate from which the socket 38 and lamps 18 extend can be used to further facilitate the withdrawal of heat to avoid overheating problems. Additionally, a thermal heat shield is commercially available for MR11, MR16 lamps. It has been found that using the above described materials, in conjunction with the metal plate that is disposed along and the top of the housing 22 and from which the socket 38 and lamps 18 extend, removes enough heat generated by the lamp 18 when it is on to allow proper operation with no greater risk of fire or heat damage than with standard lighting apparatuses of this type serving the same lighting function, and which meets international electrical standards. Any number of lamps 18 can be used, as dictated by the length of the housing 22 and the lighting that is called for from the housing 22.

Referring to FIG. 13, there is shown an apparatus 10 for lighting a room from the room's ceiling 14 or wall. The apparatus 10 comprises means for lighting including at least one lamp 18 and one transformer 20 or ballast or gear electrically connected to the lamp 18. The lamp 18 is either a low voltage or line voltage lamp 18. (Line voltage lamp, meaning a normal lamp or a metal halide or sodium or other gas-filled lamp which requires ballast or gear for their operation.) The apparatus 10 comprises means for holding the lamp 18 connected to the lighting means 16. The apparatus 10 comprises a panel 42 having at least one hole in which the holding means is disposed. The panel 42 is made of wood, glass, plastic, marble or synthetic. If a low voltage lamp is used, then a transformer is also needed. If a line voltage lamp is used, it may also require ballast or gear.

Preferably, the panel 42 is one piece. The panel 42 preferably has a plurality of holes, and including a plurality of holding means and a plurality of lamps 18. Each of the plurality of holding means is disposed in one of the plurality of holes holding one of the plurality of lamps 18. Preferably, the holding means 16 includes a gimbal ring assembly which holds the lamp 18. Preferably, the holding means includes a lamp 18 socket 38 attached to the gimbal ring 32 assembly. In the use of line voltage lamps, yokes may or may not be used in conjunction with the gimbal rings.

The present invention pertains to a method for lighting a room 12 from its ceiling 14 or wall. The method comprises the steps of mounting a gimbal ring assembly and/or yoke for holding a lamp 18 in an opening of a one-piece panel 42 made of wood, glass, plastic, marble or synthetic. There is the step of fixing the panel 42 with the gimbal ring assembly and/or yoke mounted to the panel 42 to the ceiling 14 or wall. Preferably, there is the step of connecting a transformer 20 and/or ballast or gear to a lamp 18 socket 38 attached to the gimbal ring assembly and/or yoke. The mounting step preferably includes the step of placing the lamp 18 in a lamp 18 socket 38.

In the operation of the invention, as shown in FIG. 13, a panel 42 made of wood, glass, plastic, marble or synthetic has at least one hole in it. The panel 42 can have the hole cut out of it, or the panel 42 can be formed with a desired material poured into a mold with a land that defines the hole. If more than one hole is desired in the panel 42, then there can be as many lands in the mold as desired, or as many holes as are needed can be cut out of the panel 42.

Once the panel 42 is formed with as many holes as desired, gimbal ring 32 assemblies can be attached to the holes in the panel 42. The gimbal ring 32 assemblies and/or yokes are attached with adhesive, such as epoxy, or through slots in the panel 42 about the hole which receives pins that extend from the sides of the gimbal ring 32 assembly to fix the gimbal ring 32 assemblies and/or yokes to the panel 42. Alternatively, the outer ring of the gimbal ring assembly can be attached to a sleeve having a flange that rests on the material of the panel about the hole, so the gimbal ring assembly does not fall through the hole. The sleeve can have adhesive applied to it to fit it in place on the panel. Instead of a sleeve, the gimbal ring assembly can be screwed to brackets placed across the edges of the hole to hold the gimbal ring assembly. The gimbal ring assemblies and/or yokes can be directly mounted to the panel.

The gimbal ring 32 assemblies and/or yokes each have a lamp 18 socket 38 in which the lamp 18 is placed. A transformer 20, if it is a low voltage lamp, and junction box is connected to each of the lamp 18 sockets 38 to provide electricity to the lamp 18 sockets 38 to light the lamps 18 in the lamp 18 socket 38. Ballast or gear is used with line voltage lamps.

When the panel 42 has the gimbal ring 32 assemblies affixed to it, the panel 42 with the gimbal ring 32 assemblies is placed as a unit in a gap that has been formed in the wall to receive the panel 42. The transformer 20 and other necessary equipment is placed through the gap and then the panel 42 is aligned, as desired, with the gap, and mounted to the wall with mounting or support brackets, as is well known in the art. If low voltage lamps are used, the transformer connected to them can be held in the wall adjacent to the lamps, or the transformer can be remote, connected by wiring through the wall to the lamps. The panel 42 with the gimbal ring assemblies can be similarly mounted to the ceiling.

If ballast or gear is used with certain line voltage lamps, the ballast and/or gear can be integrally mounted or remotely mounted from the lamp.

Although the invention has been described in detail in the foregoing embodiments for the purpose of illustration, it is to be understood that such detail is solely for that purpose and that variations can be made therein by those skilled in the art without departing from the spirit and scope of the invention except as it may be described by the following claims.

What is claimed is:

1. An apparatus for lighting a room from the room's ceiling or wall comprising:
means for lighting including at least one lamp and one transformer or ballast or gear electrically connected to the lamp, the lamp being either a low voltage or line voltage lamp;
means for holding the lamp connected to the lighting means; and
a panel having at least one hole in which the holding means is disposed; the panel is made of wood, glass, plastic, marble or synthetic.

2. An apparatus as described in claim 1 wherein the panel is one piece.

3. An apparatus as described in claim 2 wherein the panel has a plurality of holes, and including a plurality of holding means and a plurality of lamps, each of the plurality of holding means disposed in one of the plurality of holes holding one of the plurality of lamps.

4. An apparatus as described in claim 3 wherein the holding means includes a gimbal ring assembly or yoke which holds the lamp.

5. An apparatus as described in claim 4 wherein the holding means includes a lamp socket.

6. A method for lighting a room from its ceiling or wall comprising the steps of:
mounting a gimbal ring assembly or yoke for holding a lamp in an opening of a one-piece panel made of wood, glass, plastic, marble or synthetic; and
fixing the panel with the gimbal ring assembly mounted to the panel to the ceiling or wall.

7. A method as described in claim 6 including the step of connecting a transformer or ballast or gear to a lamp socket attached to the gimbal ring assembly or yoke.

8. A method as described in claim 7 wherein the mounting step includes the step of placing the lamp in a lamp socket.
